(19) United States
(12) Patent Application Publication
(10) Pub. No.: US 2005/0185414 A1
(43) Pub. Date: Aug. 25, 2005

(54) [COLD CATHODE FLUORESCENT FLAT LAMP]

(76) Inventors: YUI-SHIN FRAN, HSINCHU (TW); JER-SHIEN YANG, CHIA-YI HSIEN (TW); SHIH-YUAN HUANG, HSINCHU CITY (TW); LAI-CHENG CHEN, HSINCHU (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,332

(22) Filed: Apr. 29, 2004

(30) Foreign Application Priority Data
Feb. 19, 2004 (TW) 93104041

(51) Int. Cl. B60Q 1/26

(52) U.S. Cl. 362/504; 362/540; 362/541

(57) ABSTRACT

A cold cathode fluorescent flat lamp comprising a cavity, discharge gas, a plurality of electrodes, fluorescence layer and first light control layer is provided. The cavity has a light exit plane. The discharge gas is filled inside the cavity, and the electrodes may be disposed inside the cavity or outside the cavity. The cavity is divided by the protrusions of the electrodes into a plurality of first light emitting areas and second light emitting areas. The fluorescence layer is disposed on the inner wall of the cavity. The first light control layer is disposed over the fluorescence layer corresponding to the first light emitting area and the light exit plane of the cavity for reducing the light transmittance corresponding to the first light emitting area. Therefore, the first or second light control layers can increase the brightness uniformity of the whole cold cathode fluorescent flat lamp.

### CROSS REFERENCE TO RELATED APPLICATIONS

This application claims the priority benefit of Taiwan application serial no. 93104041, filed on Feb. 19, 2004.

### BACKGROUND OF INVENTION

1. Field of the Invention

The present invention generally relates to a cold cathode fluorescent flat lamp (CCFFL). More particularly, the present invention relates to a cold cathode fluorescent flat lamp having high brightness uniformity.

2. Description of Related Art

In recently years, portable electronic devices such as mobile phone, digital camera, digital video camera, notebook or desktop computer or personal computer have been developed drastically with the development of semiconductor processes and the display components. It is noted that, for all the electronic devices described above, the display device is essential and important for data input/output between the user and the device. Recently, a variety of display devices is constructed by the liquid crystal display (LCD) panel. Since the LCD panel is not self illuminant, a backlight module is required, which is typically disposed under the LCD panel as a light source.

The conventional backlight module generally includes a lamp tube, a reflection holder and a light guide plate (LGP). The light guide plate can transfer the line light source emitted by the lamp tube into surface light source. Generally, since the lamp tube is mounted on the edge of the light guide plate, the uniformity of the surface light source emitted by the light guide plate is worse. Therefore, a plurality of optical films, such as, diffuse films or brightness enhancement films is disposed above the light exit plane of the light guide plate. Therefore, the cost of the backlight module is expensive as the light guide plate and optical film are expensive. Moreover, the lamp tube, the reflector holder and the light guide plate are individual components and must be mounted by a glue trim. Therefore, the construction of the conventional backlight module is complex and high-cost.

In recent years, the cold cathode fluorescent flat lamp (CCFFL) having high luminous efficiency and uniformity is developed and provided as a surface light source, especially for a large surface area. In addition, the cold cathode fluorescent flat lamp (CCFFL) has been broadly applied as the backlight of the liquid crystal display panel and in many other applications.

The cold cathode fluorescent flat lamp (CCFFL) is a plasma light emitting component, and the principle of light emitting thereof is not exactly known, however, it is most likely as described below. First, electrons are emitted by the cathode, and thereby the inert gas in the cavity is impacted by the emitted electrons between the cathode and the anode. As a result, the inert gas is ionized into plasma and is subjected to an excited state. Next, when the atomic gas of the plasma returns to the ground state from the excited state,certain amount of energy is lost in the plasma in the form of ultraviolet light. The emitted ultraviolet light will excite the fluorescence material disposed on the cavity wall of the light tube to generate visible light.

In the discharge process described above, the light emitted by the cold cathode fluorescent flat lamp (CCFFL) is generally constructed as a line light source. When the cold cathode fluorescent flat lamp (CCFFL) is provided as a surface light source, the light on the plane is not uniform. Therefore, a local discharge process is provided by, for example,providing a plurality of protrusions on the electrodes, and thus light is emitted by point discharge at the protrusions. Hence, a cold cathode fluorescent flat lamp (CCFFL) with a larger surface area may be constructed by a plurality of local plane lamps.

However, in the local discharge process, the light intensity at the point of discharge of the cold cathode fluorescent flat lamp (CCFFL) is larger than other areas, and therefore, an interlaced brightness distribution is formed in the surface of the light source. Therefore, a better brightness uniformity of the (influence)? cold cathode fluorescent flat lamp (CCFFL) is highly desirable.

### SUMMARY OF INVENTION

Accordingly, the present invention is directed to a cold cathode fluorescent flat lamp for increasing the light intensity emitted from the region without point discharge to increase the brightness uniformity of the cold cathode fluorescent flat lamp.

In addition, the present invention is also directed to a cold cathode fluorescent flat lamp (CCFFL) for reducing the light intensity emitted by the region of point discharge to increase the brightness uniformity of the cold cathode fluorescent flat lamp.

According to an embodiment of the present invention, a cold cathode fluorescent flat lamp (CCFFL) comprising, for example but not limited to, a cavity, discharge gas, a plurality of electrodes, fluorescence layer and first light control layer is provided. The cavity has a light exit plane. The discharge gas is filled in the cavity, and the electrodes may be, for example but not limited to, disposed inside the cavity or outside the cavity. The fluorescence layer is disposed on the inner wall of the cavity. The first light control layer is disposed over the fluorescence layer corresponding to the light exit plane of the cavity.

In one embodiment of the present invention, the cavity comprises, for example but not limited to, a first substrate, a second substrate and a side bar. The second substrate is disposed over the first substrate, and the side bar is disposed between the first and the second substrates and connected to the edge thereof.

In one embodiment of the present invention, the discharge gas comprises, for example but not limited to, an inert gas such as xenon (Xe), argon (Ar) or neon (Ne).

In one embodiment of the present invention, the electrodes of the cavity comprises, for example but not limited to, a plurality of protrusions. In another embodiment of the invention, the electrodes, for example but not limited to, divide the cavity into at least one sub-cavity, and the sub-cavity is divided by the protrusions of the electrodes into a plurality of first light emitting areas and second light emitting areas. The second light emitting areas are, for example but not limited to, disposed between the first light emitting areas. The first light control layers are disposed over the fluorescence layer corresponding to the first light emitting areas.

In one embodiment of the present invention, the first light control layer may be comprised of, for example but not limited to, a fluorescence material. In another embodiment of the invention, the material of the first light control layer is, for example but not limited to, same as the material of the fluorescence layer.

In one embodiment of the present invention, the first light control layer comprises, for example but not limited to, a single patterned film layer or multi-layer stacked patterned film layer.

In one embodiment of the present invention, the cold cathode fluorescent flat lamp (CCFFL) further comprises a second light control layer disposed over the fluorescence layer corresponding to the first light control layer. In one embodiment of the present invention, the second light control layer is disposed over the fluorescence layer corresponding to the second light emitting areas.

In one embodiment of the present invention, the second light control layer comprises, for example but not limited to, a fluorescence material. In another embodiment of the invention, the material of the second light control layer is, for example but not limited to, same as the material of the fluorescence layer.

In one embodiment of the present invention, the second light control layer comprises, for example but not limited to, a single patterned film layer or multi-layer stacked patterned film layer.

In addition, the present invention provides a cold cathode fluorescent flat lamp comprising a cavity, discharge gas, a plurality of electrode, fluorescence layer and second light control layer. The cavity has a light exit plane opposite to the bottom surface. The discharge gas is filled in the cavity, and the electrodes can be disposed inside the cavity or outside the cavity. The fluorescence layer is disposed on the inner wall of the cavity. The second light control layer is disposed over the fluorescence layer corresponding to the bottom surface of the cavity.

In one embodiment of the present invention, the cavity comprises a first substrate, a second substrate and a side bar. The second substrate is disposed over the first substrate, and the side bar is disposed between the first and the second substrate and connected to the edge thereof.

In one embodiment of the present invention, the discharge gas comprises, for example but not limited to, an inert gas such as xenon (Xe), argon (Ar) or neon (Ne).

In one embodiment of the present invention, the electrodes of the cavity comprise, for example but not limited to, a plurality of protrusions. In another embodiment of the invention, the cavity is divided by the electrodes into, for example but not limited to, at least one sub-cavity, and the sub-cavity is divided by the protrusions of the electrodes into a plurality of first light emitting areas and second light emitting areas. The second light emitting areas are, for example but not limited to, disposed between the first light emitting areas. The second light control layer is disposed over the fluorescence layer corresponding to the second light emitting areas.

In one embodiment of the present invention, the second light control layer comprises, for example but not limited to, a fluorescence material. In another embodiment of the invention, the material of the second light control layer is, for example but not limited to, same as the material of the fluorescence layer.

In one embodiment of the present invention, the second light control layer comprises, for example but not limited to, a single patterned film layer or a multi-layer stacked patterned film layer.

Accordingly, in the present invention,the first or the second light control layers disposed on the fluorescence layer over the cavity wall of the cold cathode fluorescent flat lamp can increase the brightness uniformity of the light exit from the whole cold cathode fluorescent flat lamp.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The following drawings illustrate embodiments of the invention and, together with the description, serve to explain the principles of the invention.

FIG. 1 is a perspective top view schematically illustrating a cold cathode fluorescent flat lamp (CCFFL) according to one embodiment of the present invention.

FIG. 2 is a cross-sectional view along line I-I′ of FIG. 1.

FIG. 2A is a cross-sectional view along line I-I′ of FIG. 1.

FIG. 3 is a cross-sectional view along line I-I′ of FIG. 1.

FIG. 3A is a cross-sectional view along line I-I′ of FIG. 1.

FIG. 4 is a cross-sectional view along line I-I′ of FIG. 1.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The present invention is related to a design of a variety of patterns and a variety of fluorescence material with different thickness in the cold cathode fluorescent flat lamp (CCFFL) for increasing the brightness uniformity of the light emitted from the cold cathode fluorescent flat lamp. Hereinafter,some embodiments of the disposing method of the pattern and fluorescence material of the cold cathode fluorescent flat lamp will be described. However, the embodiment is only provided for the description of the invention and cannot be used to limit the scope of the present invention.

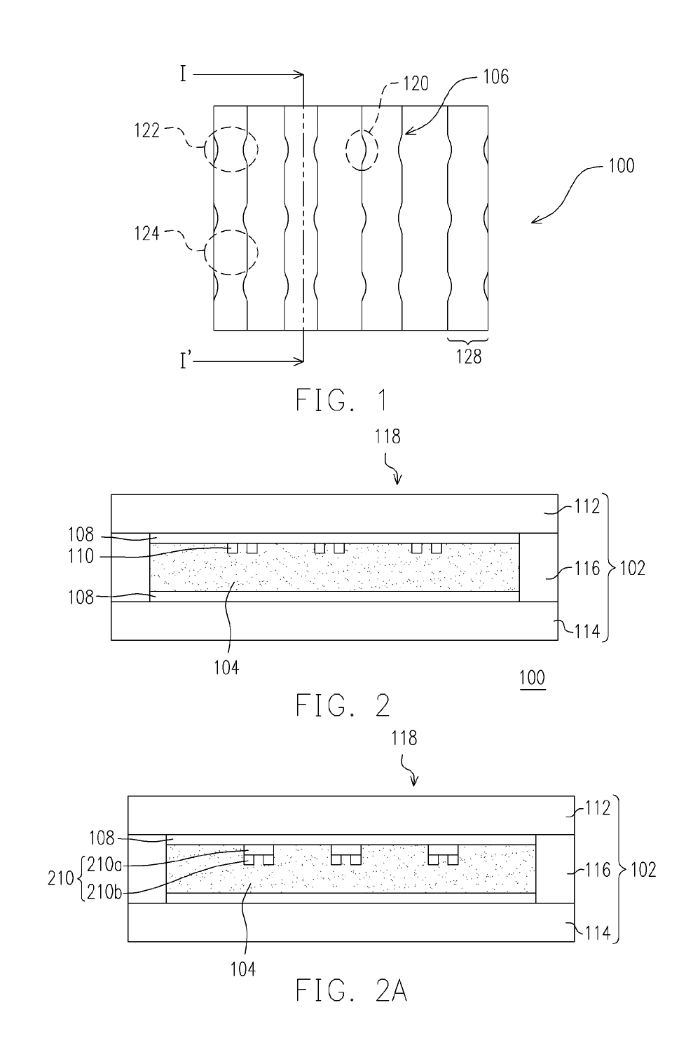

FIG. 1 is a perspective top view schematically illustrating a cold cathode fluorescent flat lamp (CCFFL) according to one embodiment of the present invention. FIG. 2 is a cross-sectional view along line I-I″ of FIG. 1. Referring to FIG. 1 and FIG. 2, the cold cathode fluorescent flat lamp (CCFFL) 100 comprises, for example but not limited to, cavity 102, discharge gas 104, electrodes 106, fluorescence layers 108 and first light control layers 110. The cavity 102 may be, for example but not limited to, a cube comprising first substrate 112, second substrate 114, side bar 116 and light exit plane 118. The fluorescence layer 108 is disposed on the inner wall of the cavity 102. In one embodiment of the present, the fluorescence layer 108 is, for example but not limited to, disposed on the first substrate 112 and the second substrate 114. The discharge gas 104 is filled in the cavity 102 and may be comprised of, for example but not limited to, xenon (Xe), neon (Ne), argon (Ar) or other inert gas.

Next, referring to FIG. 1, a plurality of electrodes 106 are disposed in the cavity 102. The cavity 102 may be divided into a plurality of sub-cavities 128 by the electrodes 106. To light up the cold cathode fluorescent flat lamp (CCFFL) 100, the suitable voltages are applied to the electrodes 106 to emit electrons, the discharge gas 104 inside the cavity 102 are impacted by the electrons, and thereby get ionized and excited into a plasma. Thereafter,the atoms of the plasma being in the excited state atom decay from the excited state to the ground state emitting ultraviolet light simultaneously. The emitted ultraviolet light will excite the fluorescence layer 108 on the inner wall of the cavity 102 to generate visible light.

It is noted that, the electrodes 106 may comprise, for example but not limited to, a plurality of protrusions 120, and thus every sub-cavity 128 is divided into, for example but not limited to, a first light emitting area 122 and a second light emitting area 124. Since the current between each pair of opposite protrusions 120 is larger, the intensity of the ultraviolet light emitted from the first light emitting area 122 is larger than that emitted from the second light emitting area 124. It is noted that, the light intensity emitted by the cold cathode fluorescent flat lamp (CCFFL) 100 is dependent on the intensity of the ultraviolet light described above, and moreover, dependent on the amount of the fluorescence substance irradiated by the ultraviolet light in a time period.

Next, referring to FIG. 2, a first light control layer 110 is disposed above the fluorescence layer 108 corresponding to the light exit plane 118 and the first light emitting area 122 of FIG. 1. Therefore, the light transmittance near the first light control layer 110 is reduced, and the light intensity exited from the first light emitting area 122 may be close to that from the second light emitting area 124. Thus, the uniformity of the emitted light of the whole surface is enhanced. In one embodiment of the invention, the first light control layer 110 is, for example but not limited to, a patterned film layer composed of grating shape, dot shape or other applicable shape with proper distribution density. The first light control layer 110 may be comprised of, for example but not limited to, a fluorescence material. In one embodiment of the invention, the material of the first light control layer 110 is same as that of the fluorescence layer 108. In addition, the first light control layer 110 is formed by, for example but not limited to, screen printing process.

It is noted that, in the embodiment described above, only one first light control layer 110 is provided. However, in the present invention, more than one light control layers may also be utilized to achieve the purpose of the present invention. In another embodiment of the present invention in, the first light control layer may be a multi-layer stacked patterned film layers,such as the first light control layer 210 shown in FIG. 2A. Referring to FIG. 2A, the first light control layer 210 comprises patterned film layer 210a and patterned film layer 210b. It is noted that, the other components in FIG. 2A except for the first light control layer 210 are similar to the components having the same reference number in FIG. 2, and therefore a detailed description thereof is omitted hereinafter.

It is noted that, in the embodiment described above, the light intensity of light emitted from the first light emitting area 122 may be decreased in order to increase the uniformity of the whole brightness of the surface light source. However, in another embodiment of the invention, the light intensity of light emitted from the second light emitting area 124 may be increased in order to increase the uniformity of the whole brightness of the surface light source. Hereinafter,the embodiment will be described.

FIG. 3 is a cross-sectional view along line I-I″ of FIG. 1. The components of FIG. 3 having the same reference numbers with the components of FIG. 2 are fabricated by similar process and provided for similar usages the corresponding components of FIG. 2 and therefore a detailed description thereof is omitted hereinafter.

Referring to FIG. 3, the second light control layer 126 is disposed above the fluorescence layer 108 of the second substrate 114 corresponding to light exit plane 118 and the second light emitting area 124 shown in FIG. 1. The second light control layer 126 is comprised of, for example but not limited to, a fluorescence material. Therefore, the amount of the fluorescence material irradiated by the ultraviolet light at any given time is increased, and thus the light intensity of the light emitted from the second light emitting area 124 is increased. In one embodiment of the invention, the material of the second light control layer 126 is similar or same as that of the fluorescence layer 108. In addition, the second light control layer 126 is formed by, for example but not limited to, a screen printing process.

In one embodiment of the invention, the second light control layer 126 comprises, for example but not limited to, a patterned film layer 126a and a patterned film layer 126b. The patterned film layer 126a, for example but not limited to, covers the fluorescence layer 108 of the second light emitting area 124 correspondingly. The patterned film layer 126b is, for example but not limited to, disposed over the dot shape or grating shape film layer of the patterned film layer 126a. The patterned film layer 126a and the patterned film layer 126b may effectively increase the area of the fluorescence material irradiated by the ultraviolet light at any given time. In other words, the fluorescence material in the second light emitting area 124 irradiated by the ultraviolet light is increased, and thus the light intensity of light emitted by the second light emitting area 124 is increased and is approximate to the light intensity of light emitted by the first light emitting area 122.

In the embodiments described above, the present invention is not limited to the second light control layer. In another embodiment of the present invention, the second light control layer may be a single patterned film layer, or a multi-layer stacked patterned film layer. Referring to FIG. 3A, the second light control layer 226 only comprises a single patterned film layer. The components of FIG. 3A except for the first light control layer 226 are the same as or similar to the components having the same reference number of FIG. 3 and therefore a detailed description thereof is omitted hereinafter.

Moreover, in another embodiment of the present invention, the cold cathode fluorescent flat lamp (CCFFL) of the invention may comprise both the first light control layer and second light control layer. Accordingly, the whole brightness uniformity of the cold cathode fluorescent flat lamp (CCFFL) may be further improved.

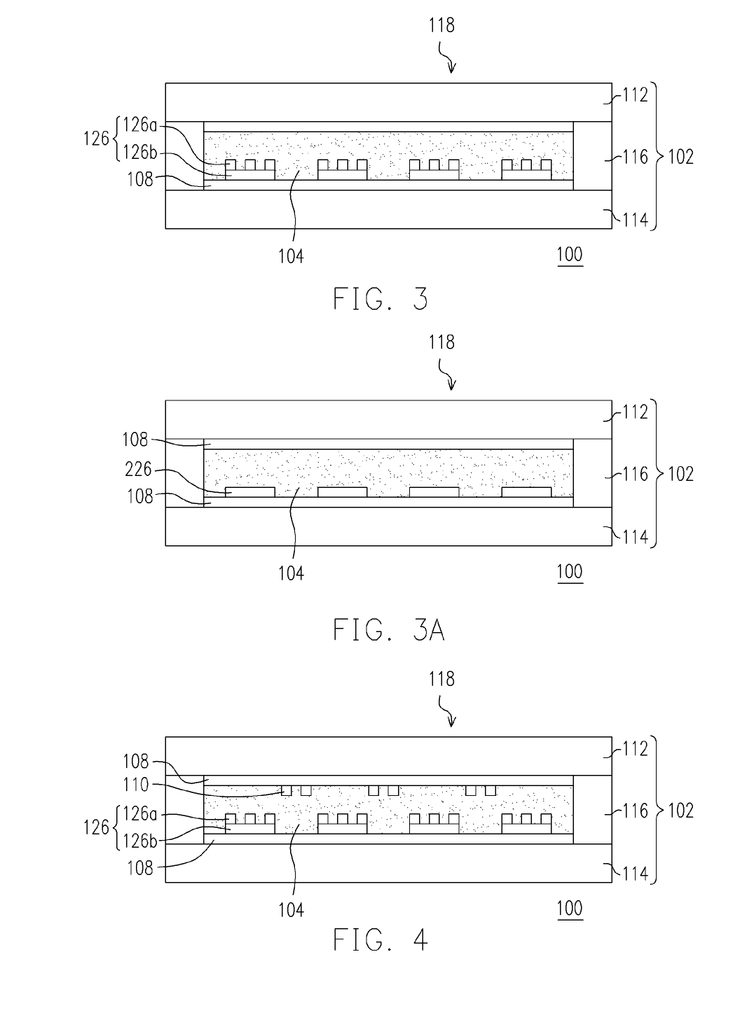

FIG. 4 is a cross-sectional view along line I-I″ of FIG. 1. The embodiment shown in FIG. 4 is a combination of the embodiments shown in FIG. 2 and FIG. 3. In the cold cathode fluorescent flat lamp (CCFFL) of the present embodiment, a first light control layer 110 is disposed above the fluorescence layer 108 corresponding to the light exit plane 118 and the first light emitting area 122 (as shown in FIG. 1). Moreover, a second light control layer 126 is disposed above the fluorescence layer 108 of the second substrate 114 corresponding to the first light control layer 110 and the second light emitting area 124 shown in FIG. 1. Therefore, in the present embodiment, the light transmittance from the first light control layer 110 is reduced, and thus the light intensity of light emitted from the first light emitting area 122 is reduced. In addition, the amount of the fluorescence material irradiated by the ultraviolet light at any time is increased by the second light control layer 126, therefore the light intensity of light emitted from the second light emitting area 124 is increased.

Accordingly, in the present invention,one or multilayer stacked light control layer is disposed over the fluorescence layer inside the cavity wall of the cold cathode fluorescent flat lamp (CCFFL). Therefore, the brightness uniformity of the whole cold cathode fluorescent flat lamp (CCFFL) is enhanced. Since the present invention can solve the problem of the interlaced brightness of the conventional local discharge plane lamp, the present invention may be provided for manufacturing a cold cathode fluorescent flat lamp (CCFFL) having high brightness uniformity and a large surface area.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A cold cathode fluorescent flat lamp, comprising:
a cavity, having a light exit plane;
a discharge gas, disposed inside the cavity;
a plurality of electrodes, disposed inside the cavity or outside the cavity;
a fluorescence layer, disposed on an inner wall of the cavity; and
a first light control layer, disposed over the fluorescence layer corresponding to the light exit plane.

2. The cold cathode fluorescent flat lamp of claim 1, wherein the cavity comprises:
a first substrate;
a second substrate, disposed over the first substrate; and
a side bar, disposed between the first substrate and the second substrate and connected to an edge of the first substrate and an edge of the second substrate.

3. The cold cathode fluorescent flat lamp of claim 1, wherein the discharge gas comprises an inert gas.

4. The cold cathode fluorescent flat lamp of claim 3, wherein the inert gas comprises xenon (Xe), neon (Ne) or argon (Ar).

5. The cold cathode fluorescent flat lamp of claim 1, wherein each of the electrodes comprise a plurality of protrusions.

6. The cold cathode fluorescent flat lamp of claim 5, wherein the cavity is divided by the electrodes into at least one sub-cavity, and the sub-cavity is divided by the protrusions of the electrodes into a plurality of first light emitting areas and a plurality of second light emitting areas disposed between the first light emitting areas.

7. The cold cathode fluorescent flat lamp of claim 6, wherein the first light control layer is disposed over the fluorescence layer corresponding to the first light emitting area.

8. The cold cathode fluorescent flat lamp of claim 1, wherein a material of the first light control layer comprises a fluorescence material.

9. The cold cathode fluorescent flat lamp of claim 1, wherein a material of the first light control layer and a material of the fluorescence layer are same.

10. The cold cathode fluorescent flat lamp of claim 1, wherein the first light control layer comprises single patterned film layer or multi-layer stacked patterned film layer.

11. The cold cathode fluorescent flat lamp of claim 1, further comprising:
a second light control layer, disposed over the fluorescence layer corresponding to the second light emitting area.

12. The cold cathode fluorescent flat lamp of claim 11, wherein a material of the second light control layer comprises fluorescence material.

13. The cold cathode fluorescent flat lamp of claim 11, wherein a material of the second light control layer and a material of the fluorescence layer are same.

14. The cold cathode fluorescent flat lamp of claim 11, wherein the second light control layer comprises single patterned film layer or multi-layer stacked patterned film layer.

15. A cold cathode fluorescent flat lamp, comprising:
a cavity, having a light exit plane and a bottom surface, wherein the light exit plane is opposite to the bottom surface;
a discharge gas, disposed inside the cavity;
a plurality of electrodes, disposed inside the cavity or outside the cavity;
a fluorescence layer, disposed on an inner wall of the cavity; and
a second light control layer, disposed over the fluorescence layer on and corresponding to the bottom surface.

16. The cold cathode fluorescent flat lamp of claim 15, wherein the cavity comprising:
a first substrate;
a second substrate, disposed over the first substrate top; and
a side bar, disposed between the first substrate and the second substrate between and connected to an edge of the first substrate and an edge of the second substrate.

17. The cold cathode fluorescent flat lamp of claim 15, wherein the discharge gas comprises inert gas.

18. The cold cathode fluorescent flat lamp of claim 15, wherein the inert gas comprises xenon (Xe), neon (Ne) or argon (Ar).

19. The cold cathode fluorescent flat lamp of claim 15, wherein each of the electrodes comprises a plurality of protrusions.

20. The cold cathode fluorescent flat lamp of claim 19, wherein the cavity is divided by the electrodes into at least one sub-cavity, and the sub-cavity is divided by the protrusions of the electrodes into a plurality of first light emitting areas and a plurality of second light emitting areas disposed between the first light emitting areas.

21. The cold cathode fluorescent flat lamp of claim 20, wherein the second light control layer is disposed over the fluorescence layer corresponding to the second light emitting area.

22. The cold cathode fluorescent flat lamp of claim 15, wherein a material of the second light control layer comprises a fluorescence material.

23. The cold cathode fluorescent flat lamp of claim 15, wherein a material of the second light control layer and a material of the fluorescence layer are same.

24. The cold cathode fluorescent flat lamp of claim 15, wherein the second light control layer comprises single patterned film layer or multi-layer stacked patterned film layer.
